(19) United States
(12) Patent Application Publication
(10) Pub. No.: US 2009/0307492 A1
(43) Pub. Date: Dec. 10, 2009

(54) METHOD,SYSTEM AND NETWORK DEVICE FOR BIDIRECTIONAL AUTHENTICATION

(76) Inventors: Zhenfu CAO, Shenzhen (CN); Xiaolei DONG, Shenzhen (CN); Rongxing LU, Shenzhen (CN); Zhenchuan CHAI, Shenzhen (CN); Jiwei WEI, Shenzhen (CN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/537,659

(22) Filed: Aug. 7, 2009

Related U.S. Application Data
(63) Continuation of application No. PCT/CN2008/073097, filed on Nov. 18, 2008.

(30) Foreign Application Priority Data
Nov. 19, 2007 (CN) 200710177632.5

(51) Int. Cl. H04L 9/32

(52) U.S. Cl. 713/169; 713/168

(57) ABSTRACT

A bidirectional authentication method, a system, and a network device, that relates to network information security are provided. The method may include: a network device configured to generate an inspection parameter according to a public key of the peer network device and a private key of the network device, the public key and the private key of the network device being generated according to an identifier of the network device. The network device may perform reciprocal authentication according to the inspection parameter generated by the network device and an inspection parameter sent by the peer network device. A system and a network device for bidirectional authentication are also provided herein. As such, extra calculation caused by certificate authentication may be reduced, and thus provide a more secure and reliable system having a simplified key management.

### CROSS-REFERENCE TO RELATED APPLICATIONS

This application is a continuation of International Application No. PCT/CN2008/073097, filed on Nov. 18, 2008, which claims priority to Chinese patent application No. 200710177632.5, filed with the Chinese Patent Office on Nov. 19, 2007 and entitled “Method, System, and Network Terminal for Bidirectional Authentication”, the entire contents of which are incorporated herein by reference.

### FIELD

The disclosed embodiments relate to network information security, and in particular, to a method, a system, and a network device for bidirectional authentication.

### BACKGROUND

For designers and developers of most systems and application networks, security is always a challenging and critical issue. For both ordinary PC systems and the gateway systems of the enterprise, various attacks and unauthorized accesses tend to cause loss of key data, and thus cause inestimable losses.

On Apr. 8, 2003, the Trusted Computing Group (TCG) was founded. As an industry recognized standards organization, the TCG has designed basic modules of trusted hardware, and developed trusted software to resist various virtual or physical attacks. The products under such standards can be easily applied to embedded design.

A Trusted Platform Module (TPM) is a basis of trusted computing. Generally, a TPM is a small piece of silicon attached to a device, namely, a security micro controller capable of cryptographic operation. The TPM is assembled together with the PC chipset through a Low Pin Count (LPC) bus. The TPM is responsible for: (1) storing confidential information such as password, certificate, and key information, with a view to preventing software attacks; (2) generating high-quality keys through a random number generator; (3) performing private key processing within a unit; and (4) storing standard information related to software integrity for estimating integrity of executable software.

As a basis of trusted computing, the TPM is applicable not only to ordinary PCs and other computing devices, but also to the Internet. By implanting a TPM on each network terminal, a trusted Internet platform is constructed.

However, the prior art may have at least the following defects:

Reciprocal authentication and key negotiation between both parties to communication are a basis of the trusted Internet. The TPM module in the prior art implements authentication based on the cryptographic system of the Public Key Infrastructure (PKI), and an extra digital certificate is required to bind the public key of the platform to the platform identity (such as serial number). Consequently, in the process of authenticating the platform, the certificate needs to be authenticated additionally. Moreover, transmission of the certificate occupies extra network bandwidth, and the management on the certificate is rather complicated and requires support of the PKI.

### SUMMARY

In order to make the authentication process of the trusted network platform simpler and more reliable, a bidirectional authentication method, a system, and a network device are disclosed in various embodiments by reference to the identity-based cryptography. Disclosed embodiments may include the following:

A method for bidirectional authentication is provided. The method may include:

generating, by a first network device, an inspection parameter according to a public key of the second network device and a private key of the first network device;

generating, by the second network device, an inspection parameter according to a public key of the first network device and a private key of the second network device, where the public key and the private key of the first network device are obtained according to an identifier of the first network device, and the public key and the private key of the second network device are obtained according to an identifier of the second network device;

authenticating, by the first network device, the second network device according to the inspection parameter generated by the first network device and the inspection parameter received from the second network device; and

authenticating, by the second network device, the first network device according to the inspection parameter generated by the second network device and the inspection parameter received from the first network device.

A network system is provided. The system may include:

a first network device, configured to: generate an inspection parameter according to the public key of the second network device and the private key of the first network device, receive the inspection parameter from the second network device, and perform authentication with the second network device according to the generated inspection parameter and the received inspection parameter; and

a second network device, configured to: generate an inspection parameter according to the public key of the first network device and the private key of the second network device, receive the inspection parameter from the first network device, and perform authentication with the first network device according to the generated inspection parameter device and the received inspection parameter.

A network device is provided. The network device may include:

a public key and private key generating module, configured to generate a public key and a private key of the network device according to an identifier of the network device; and

an authenticating module, configured to: generate an inspection parameter according to the public key of the peer network device and the private key of the network device, receive the inspection parameter from the peer network device, and perform authentication with the peer network device according to the inspection parameter generated by the network device and the received inspection parameter.

The disclosed embodiments may provide the following benefits:

The identity-based cryptography is integrated and applied to a trusted Internet platform. The device identity is a public key, without requiring extra certificates. Therefore, extra calculation caused by certificate authentication is cut down, and the network may perform reciprocal authentication and key negotiation directly after being deployed.

### BRIEF DESCRIPTION OF THE DRAWINGS

The foregoing summary, as well as the following detailed description of the disclosed embodiments, will be better understood when read in conjunction with the appended drawings. For the purpose of illustrating the disclosed embodiments, there are shown in the drawings that are presently preferred. It should be understood however, that the embodiments are not limited to the precise arrangement and instrumentalities shown.

FIG. 1 is a flowchart of a bidirectional authentication method disclosed in a first embodiment;

FIG. 2 is a network system disclosed in a second embodiment;

FIG. 3 shows a network device disclosed in a third embodiment; and

FIG. 4 shows a network device disclosed in a fourth embodiment

### DETAILED DESCRIPTION

The disclosed embodiments are hereinafter described in detail with reference to exemplary embodiments and accompanying drawings, but the disclosed embodiments are not limited to the following embodiments

The disclosed embodiments combine the TPM with the identity-based cryptography, and provide a method, a system and a network device of bidirectional authentication based on an elliptic curve bilinear pairing technology. The method disclosed may include:

generating, by a first network device, an inspection parameter according to a public key of the second network device and a private key of the first network device;

generating, by the second network device, an inspection parameter according to a public key of the first network device and a private key of the second network device, where the public key and the private key of the first network device are obtained according to an identifier of the first network device, and the public key and the private key of the second network device are obtained according to an identifier of the second network device;

authenticating, by the first network device, the second network device according to the inspection parameter generated by the first network device and the inspection parameter received from the second network device; and

authenticating, by the second network device, the first network device according to the inspection parameter generated by the second network device and the inspection parameter received from the first network device.

If the first network device is a first network terminal and the second network device is a second network terminal, the method consistent with some embodiments is detailed below.

First, the involved parameters are defined hereinafter.

Supposing that G₁ is a cyclic additive group and G₂ is a cyclic multiplicative group, and they have the same prime order q, e: G₁×G₁→G₂ is a bilinear mapping, which takes on the following three characteristics:

Bilinearity: For any P,QεG₁ and a,bεZ_{q}*, e(aP,bQ)=e(P,Q)^{ab}, where Z_{q}* is a set of all positive integers that are less than q and coprime with q;

Non-degeneration: pεG₁, QεG₁, and e(P,Q)≠1; and

Computability: For any P, QεG₁, a polynomial time algorithm exists for calculating e(P,Q).

Supposing that G₁ is a Gap Diffie-Hellman group, namely, the computing-related Diffie-Hellman problems in G₁ are difficult but the judging-related Diffie-Hellman problems in G₁ are less difficult, the open parameters of the system are {G₁,G₂,q,P)}.

Afterward, the system initialization is performed as below.

First, the trusted network key distributor generates a system parameter according to the security parameter 1^{k}:

[symbol]

q,G₁,G₂,e,s,P,P_{pub}=sP,H₁,H₂,H₃ [symbol] ,

where:

q is a prime number;

G₁ is a cyclic additive group using the prime number q as an order and G₂ is a cyclic multiplicative group using the prime number q as an order;

e:G₁×G₁→G₂ is a bilinear mapping;

s is a value selected from the group Z_{q}* randomly as a private key of the trusted network key distributor;

P is a generator of G₁; P_{pub}=sP serves as the corresponding public key of the system; and

H₁:{0,1}*→G₁, H₂:{0,1}*→{0,1}^{l}, and H₃:{0,1}*→{0,1}^{l} are cryptographic Hash functions, where l is another security parameter and k is the bit length.

Besides, trusted network key distributor generates a trusted group key SK_{TG} Throughout the system, each network terminal can calculate the peer public key Q_{I}=H₁(ID_{I})εG₁ through the H₁:{0,1}*→G₁ and the unique identifier ID_{I} of the peer.

The TPM distributes keys and sets up a trusted network terminal. When a network terminal becomes a trusted network terminal, the trusted network key distributor generates the corresponding terminal private key S_{I}=sH₁(ID_{I}) according to the terminal identifier ID_{I}, and then injects the system parameter [symbol] q,G₁,G₂,e,s,P,P_{pub}=sP,H₁,H₂,H₃ [symbol] , the terminal private key S_{I} and the trusted group key SK_{TG} into the TPM, and finally embeds the TPM into the network terminal, thus setting up a trusted network terminal.

The trusted group key SK_{TG} is distributed to each network terminal through the TPM, thus accomplishing reciprocal authentication between the trusted network terminals. The terminals other than the trusted group are unaware of the key of the trusted group, and therefore, are not responsive to reciprocal authentication. If secure communication is performed between two trusted network terminals on the trusted network platform, bidirectional authentication is performed and a security session key is created.

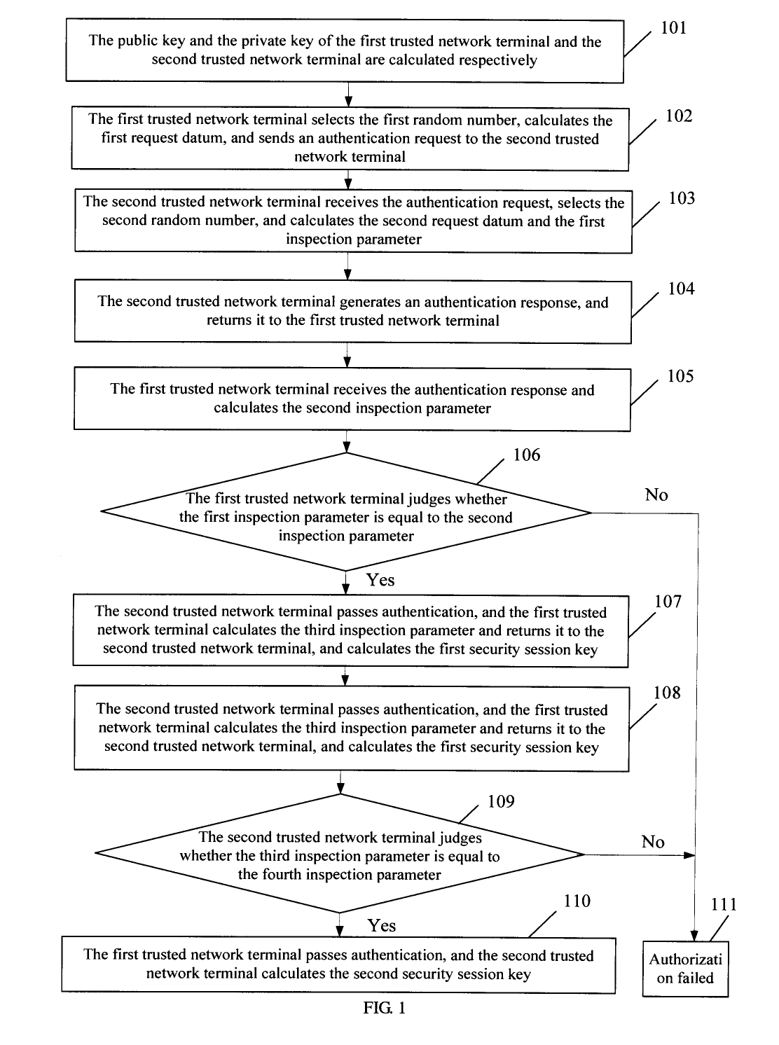

As shown in FIG. 1, a method of bidirectional authentication on a trusted network platform is provided.

The method may include:

generating a public key and a private key of the network terminal according to the network terminal identifier;

sending, by the first network terminal, an authentication request to the second network terminal;

generating, by the second network terminal, the first inspection parameter according to the public key of the first network terminal and the private key of the second network terminal, and returning an authentication response inclusive of the first inspection parameter to the first network terminal;

generating, by the first network terminal, the second inspection parameter according to the public key of the second network terminal and the private key of the first network terminal, and authenticating the second network terminal according to the first inspection parameter and the second inspection parameter;

generating the third inspection parameter according to the public key of the second network terminal and the private key of the first network terminal, and returning the third inspection parameter to the second network terminal; and

generating, by the second network terminal, the fourth inspection parameter according to the public key of the first network terminal and the private key of the second network terminal, and authenticating the first network terminal according to the third inspection parameter and the fourth inspection parameter.

Supposing that the first network terminal is a first trusted network terminal NT-A and the second network terminal is a second trusted network terminal NT-B for performing network security communication, the method may include the following steps:

Step 101: The public key, namely, Q_{A}=H₁(ID_{A}), of the first trusted network terminal NT-A is calculated. The private key of the corresponding first trusted network terminal NT-A is S_{A}=sH₁(ID_{A}), the public key of the second trusted network terminal NT-B is Q_{B}=H₁(ID_{B}), and the private key of the corresponding second trusted network terminal NT-B is S_{B}=sH₁(ID_{B}).

The identifier of the first trusted network terminal NT-A is ID_{A}, and the identifier of the second trusted network terminal NT-B is ID_{B}.

Step 102: The first trusted network terminal NT-A selects a random number r_{A}εZ_{q}*, called a first random number. The first request datum r_{A}P is calculated, and the authentication request (ID_{A},r_{A}P) is sent to the second trusted network terminal NT-B.

Step 103: After receiving the authentication request (ID_{A},r_{A}P), the second trusted network terminal NT-B selects another random number r_{B}εZ_{q}*, called a second random number, calculates the second request datum r_{B}P, and obtains the first inspection parameter by performing Hash operation for these values: the first adjoining value obtained by adjoining the NT-A ID (ID_{A}) with the NT-B ID (ID_{B}) carried in the authentication request, the first request datum r_{A}P, the second request datum r_{B}P, the product of the first request datum and the second random number, the first mapping value generated by mapping the NT-A public key Q_{A} and the NT-B private key S_{B} to the elements in the cyclic multiplicative group through bilinear pairing, and the trusted group key:

K_{B}=H₂(ID_{A}∥ID_{B},r_{A}P,r_{B}P,r_{A}r_{B}P,e(Q_{A},S_{B}),SK_{TG}).

All data for negotiation in the session may be used as input of the Hash function to make the session setup more trustworthy and secure. In this way, attackers are unable to make use of or alter the session setup information.

Step 104: The NT-B generates an authentication response (ID_{B},r_{B}P,K_{B}), and returns it to NT-A.

Step 105: After receiving the authentication response (ID_{B},r_{B}P,K_{B}), NT-A obtains the second inspection parameter by performing Hash operation for these values: the second adjoining value obtained by adjoining the NT-A ID (ID_{A}) with the NT-B ID (ID_{B}) carried in the received authentication response, the first request datum r_{A}P, the second request datum r_{B}P, the product of the second request datum and the first random number, the second mapping value generated by mapping the NT-B public key Q_{B} and the NT-A private key S_{A} to the elements in the cyclic multiplicative group through bilinear pairing, and the trusted group key:

K′_{B}=H₂(ID_{A}∥ID_{B},r_{A}P,r_{B}P,r_{A}r_{B}P,e(Q_{B},S_{A}),SK_{TG}).

Step 106: NT-A judges whether the inspection parameter K_{B} is equal to the inspection parameter K′_{B}. If they are equal, the process proceeds to step 107; otherwise, the process proceeds to step 111.

Step 107: NT-B passes the authentication. NT-A obtains the third inspection parameter by performing Hash operation for these values: the third adjoining value obtained by adjoining the NT-B ID (ID_{B}) with the NT-A ID (ID_{A}), the first request datum r_{A}P, the second request datum r_{B}P, the product of the second request datum and the first random number, the second mapping value generated by mapping the NT-B public key Q_{B} and the NT-A private key S_{A} to the elements in the cyclic multiplicative group through bilinear pairing, and the trusted group key:

K_{A}=H₂(ID_{B}∥ID_{A},r_{A}P,r_{B}P,r_{A}r_{B}P,e(Q_{B},S_{A}),SK_{TG}).

NT-A returns the third inspection parameter K_{A} to NT-B. NT-A obtains the first security session key by performing Hash operation for these values: the adjoining value obtained by adjoining the NT-A ID (ID_{A}) with the NT-B ID (ID_{B}), the first request datum (r_{A}P), the second request datum (r_{B}P), the product of the first request datum and the second random number, the second mapping value generated by mapping the NT-B public key Q_{B} and the NT-A private key S_{A} to the elements in the cyclic multiplicative group through bilinear pairing, and the trusted group key:

SK_{A}=H₂(ID_{A}∥ID_{B},r_{A}P,r_{B}P,r_{A}r_{B}P,e(Q_{B},S_{A}),SK_{TG}).

Step 108: After receiving the third inspection parameter K_{A} from NT-A, NT-B obtains the fourth inspection parameter by performing Hash operation for these values: the fourth adjoining value obtained by adjoining the NT-B ID (ID_{B}) with the NT-A ID (ID_{A}), the first request datum r_{A}P, the second request datum r_{B}p, the product of the second request datum and the first random number, the first mapping value generated by mapping the NT-B public key Q_{B} and the NT-A private key S_{A} to the elements in the cyclic multiplicative group through bilinear pairing, and the trusted group key:

K′_{A}=H₂(ID_{B}∥ID_{A},r_{A}P,r_{B}P,r_{A}r_{B}P,e(Q_{A},S_{B}),SK_{TG}).

Step 109: NT-B judges whether the inspection parameter K′_{A} is equal to the inspection parameter K_{A}. If they are equal, the process proceeds to step 110; otherwise, the process proceeds to step 111.

Step 110: NT-A passes the authentication. NT-B obtains the second security session key by performing Hash operation for these values: the adjoining value obtained by adjoining the NT-B ID (ID_{B}) with the NT-A ID (ID_{A}), the first request datum r_{A}P, the second request datum r_{B}P the product of the second request datum and the first random number, the first mapping value generated by mapping the NT-B public key Q_{B} and the NT-A private key S_{A} to the elements in the cyclic multiplicative group through bilinear pairing, and the trusted group key:

SK_{B}=H₂(ID_{A}∥ID_{B},r_{A}P,r_{B}P,r_{A}r_{B}P,e(Q_{A},S_{B}),SK_{TG}).

Step 111: Authentication fails.

In e(Q_{A},S_{B}), S_{B}=sQ_{B} namely, e(Q_{A},S_{B})=e(Q_{A},sQ_{B}). Likewise, e(Q_{B},S_{A})=e(Q_{B},sQ_{A}). Due to bilinearity, e(Q_{A},S_{B})=e(Q_{A},sQ_{B})=e(Q_{A},Q_{B})^{s} and e(Q_{B},S_{A})=e(Q_{B},sQ_{A})=e(Q_{B},Q_{A})^{s}, namely, e(Q_{A},S_{B})=e(Q_{B},S_{A})=e(Q_{A},Q_{B})^{s}. Therefore, the first security session key SK_{A} is equal to the second security session key SK_{B}. Meanwhile, the trusted group key SK_{TG} is included in the protocol. Therefore, the terminals outside the group are unable to authenticate the terminals in the group, thus accomplishing the secret handshake protocol.

The trusted group key SK_{TG} is designed to specify that only the members in the group can join the authentication. In general authentication solutions, the trusted group key SK_{TG} is not necessarily applied.

The method disclosed above is applicable to telecom networks (including mobile networks and fixed networks) and the Internet. Accordingly, the foregoing network terminal may be: a base station, mobile terminal, core node, or border gateway in the mobile network; or a router in the fixed network; or a computer terminal or router in the Internet, and so on. Network terminals include but are not limited to the foregoing network nodes.

Besides, the trusted network key distributor disclosed herein is a logical function entity. The function of the trusted network key distributor may be implemented by setting a stand-alone server, and be integrated in the existing network device. For example, supposing that the method herein is applied to a mobile network, the function of the trusted network key distributor may be integrated in the Home Subscriber Server (HSS)/Home Location Register (HLR) in the existing mobile network, or implemented through a Key Derivation Function (KDF). This embodiment does not impose any restriction onto the specific mode of implementing the trusted network key distributor.

In this embodiment, the identity-based cryptography is integrated and applied to a trusted Internet platform. The device identity is a public key, without requiring extra certificates. Therefore, extra calculation caused by certificate authentication is cut down, and the network can perform reciprocal authentication and key negotiation directly after being deployed.

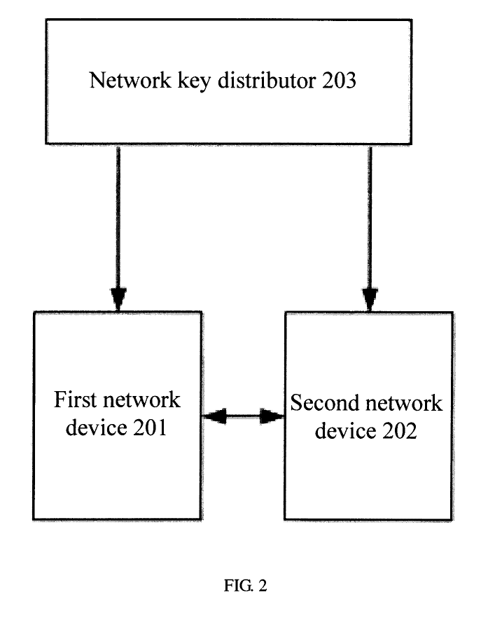

As shown in FIG. 2, a network system is disclosed in this embodiment. The network system includes:

a first network device 201, configured to: generate an inspection parameter according to the public key of the second network device 202 and the private key of the first network device 201, receive the inspection parameter from the second network device 202, and perform authentication with the second network device 202 according to the generated inspection parameter and the received inspection parameter; and

a second network device 202, configured to: generate an inspection parameter according to the public key of the first network device 201 and the private key of the second network device 202, receive the inspection parameter from the first network device 201, and perform authentication with the first network device 201 according to the generated inspection parameter and the received inspection parameter.

Further, the network system disclosed in this embodiment includes:

a network key distributor 203, configured to: generate a system parameter and a group key, and generate a private key of the network device according to an identifier of the network device;

accordingly,

a first network device 201, configured to: generate a public key of the network device according to an identifier of the network device, generate the second inspection parameter according to the public key of the second network device 202 and the private key of the first network device 201, authenticate the second network device 202 according to the first inspection parameter and the second inspection parameter, generate the third inspection parameter according to the public key of the second network device 202 and the private key of the first network device 201, and return the third inspection parameter to the second network device 202; and

a second network device 202, configured to: generate a public key of the network device according to an identifier of the network device, generate the first inspection parameter according to the public key of the first network device 201 and the private key of the second network device 202, return an authentication response inclusive of the first inspection parameter to the first network device 201, generate the fourth inspection parameter according to the public key of the first network device 201 and the private key of the second network device 202, and authenticate the first network device 201 according to the third inspection parameter and the fourth inspection parameter.

The system disclosed above is applicable to telecom networks (including mobile networks and fixed networks) and the Internet. Accordingly, the foregoing network device may be a base station, mobile terminal, core node, or border gateway in the mobile network; or a router in the fixed network; or a computer terminal or router in the Internet, and so on. Network terminals include but are not limited to the foregoing network nodes.

In this embodiment, the identity-based cryptography is integrated and applied to a trusted Internet platform. The device identity is a public key, without requiring extra certificates. Therefore, extra calculation caused by certificate authentication may be reduced, and the network devices can perform reciprocal authentication and key negotiation directly after being deployed.

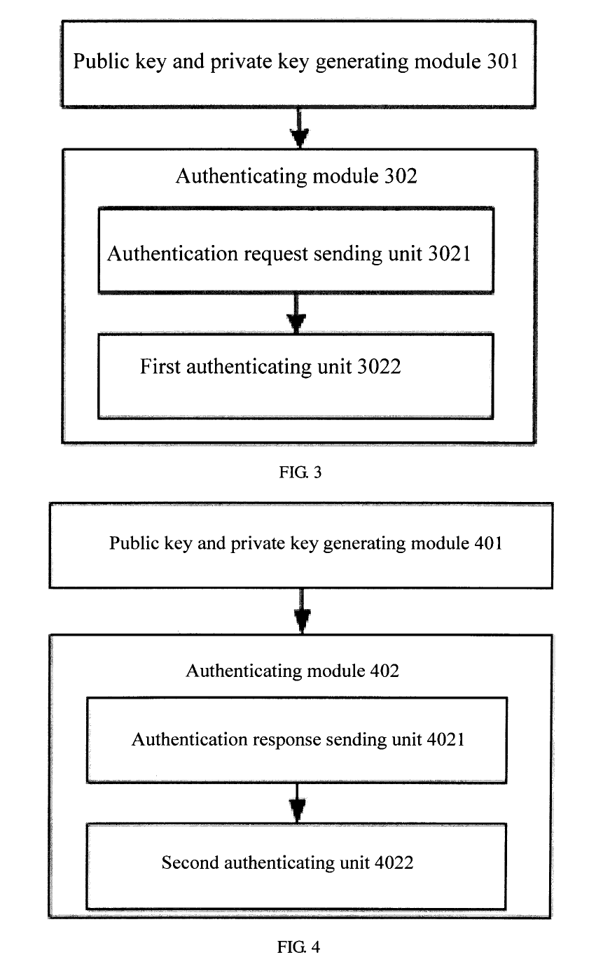

A network device is disclosed in this embodiment. The network device is configured to: generate an inspection parameter according to the public key of the peer network device and the private key of the network device, receive the inspection parameter from the peer network device, and perform authentication with the peer network device according to the generated inspection parameter and the received inspection parameter. As shown in FIG. 3, the network device includes:

a public key and private key generating module 301, configured to generate a public key and a private key of the network device according to an identifier of the network device; and

an authenticating module 302, configured to: generate an inspection parameter according to the public key of the peer network device and the private key of the network device, receive the inspection parameter from the peer network device, and perform authentication with the peer network device according to the inspection parameter generated by the network device and the received inspection parameter.

The network device authenticating module 302 includes:

an authentication request sending unit 3021, configured to send an authentication request to the peer network device; and

a first authenticating unit 3022, configured to: generate the second inspection parameter according to the public key of the peer network device and the private key of the network device, authenticate the peer network device according to the first inspection parameter sent by the peer network device and the second inspection parameter, generate the third inspection parameter according to the public key of the peer network device and the private key of the network device, and return the third inspection parameter to the peer network device.

The public key and private key generating module 301 includes: a network identifier obtaining unit, configured to obtain a network device identifier; and a Hash operation unit, configured to perform Hash function operation for an identifier of the network device, and generate at least one Hash operation value which is the public key of the network device.

Further, the network device disclosed in this embodiment includes a first security session key generating module, configured to: map the public key of the peer network device and the private key of the network device to the elements in the cyclic multiplicative group through bilinear pairing, and generate a mapping value; and generate a security session key according to the mapping value and the group key.

The network device disclosed above may be a basestation, mobile terminal, core node, or border gateway in the mobile network; or a router in the fixed network; or a computer terminal or router in the Internet, and so on. Network devices include but are not limited to the foregoing network nodes.

In the network device disclosed in this embodiment, the identity-based cryptography is integrated and applied to a trusted Internet platform. The device identity is a public key, without requiring extra certificates. Therefore, extra calculation caused by certificate authentication may be reduced, and the network device can perform reciprocal authentication and key negotiation directly after being deployed.

A network device is disclosed in this embodiment. The network device is configured to: generate an inspection parameter according to the public key of the peer network device and the private key of the network device, receive the inspection parameter from the peer network device, and perform authentication with the peer network device according to the generated inspection parameter and the received inspection parameter. As shown in FIG. 4, the network device includes:

a public key and private key generating module 401, configured to generate a public key and a private key of the network device according to an identifier of the network device; and

an authenticating module 402, configured to: generate an inspection parameter according to the public key of the peer network device and the private key of the network device, receive the inspection parameter from the peer network device, and perform authentication with the peer network device according to the inspection parameter generated by the network device and the received inspection parameter.

The network device authenticating module 402 includes:

an authentication response sending unit 4021, configured to: generate the first inspection parameter according to the public key of the peer network device and the private key of the network device, and returning an authentication response inclusive of the first inspection parameter to the peer network device; and

a second authenticating unit 4022, configured to: generate the fourth inspection parameter according to the public key of the peer network device and the private key of the network device, and authenticate the peer network device according to the third inspection parameter sent by the peer network device and the fourth inspection parameter.

The public key and private key generating module 401 includes: a network identifier obtaining unit, configured to obtain a network device identifier; and a Hash operation unit, configured to: perform Hash function operation for an identifier of the network device, and generate at least one Hash operation value which is the public key of the network device.

Further, the network device includes a second security session key generating module, configured to: map the public key of the peer network device and the private key of the network device to the elements in the cyclic multiplicative group through bilinear pairing, and generate a mapping value; and generate a security session key according to the mapping value and the group key.

The network device disclosed above may be: a base station, mobile terminal, core node, or border gateway in the mobile network; or a router in the fixed network; or a computer terminal or router in the Internet, and so on. Network devices include but are not limited to the foregoing network nodes.

In the network device disclosed in this embodiment, the identity-based cryptography is integrated and applied to a trusted Internet platform. The device identity is a public key, without requiring extra certificates. Therefore, extra calculation caused by certificate authentication may be reduced, and the network device can perform reciprocal authentication and key negotiation directly after being deployed.

To sum up, the bidirectional authentication method, the system, and the network device disclosed herein are based on the elliptic curve bilinear pairing technology and the identity-based cryptography. The device identity is a public key, without requiring extra certificates. Therefore, extra calculation caused by certificate authentication may be reduced, and the network can perform reciprocal authentication and key negotiation directly after being deployed. Each network device has a group key shared by the whole group and a private key of each device, thus providing high security and practicality. The group key ensures the network devices in the same group to perform reciprocal authentication and key negotiation, and the private key of each terminal prevents impact on other devices when the group key of a device is cracked, which is essential in large networks. This feature protects the existing investments after a device is cracked, without the need of replacing the private key of other devices. The identity-based trusted chip is conducive to network deployment, and simplifies key management.

Part of the steps in the foregoing embodiments may be implemented through computer-readable code tangibly embodied on a computer-readable medium. For example, the computer-readable code may be stored in a computer-readable storage medium, such as PC floppy disk, hard disk, and compact disk.

The word “receive” in the disclosed embodiments may be understood as obtaining information from other modules proactively or receiving the information sent by other modules.

It is understandable to those skilled in the art that the accompanying drawings are for illustrating the preferred embodiments only, and the modules or processes in the accompanying drawings are not mandatory.

It is understandable to those skilled in the art that the modules in the apparatuses in the embodiments may be distributed in the apparatuses in the way described herein, or distributed in other ways, for example, in one or more other apparatuses. The modules in the foregoing embodiments may be combined into one, or split into several submodules.

After reading the foregoing embodiments, those skilled in the art are clearly aware that the disclosed embodiments may be implemented through hardware, or through software in addition to a necessary universal hardware platform. Therefore, examples consistent with the disclosed embodiments may be tangibly embodied as a computer program produce. The computer program product may be stored in a non-volatile storage medium (such as CD-ROM, USB flash disk, or mobile hard disk), and may include several instructions that enable a computer device (such as personal computer, server, or network device) to perform the methods disclosed in the embodiments.

Although the examples have been described through some exemplary embodiments, the disclosed embodiments are not limited to such embodiments. It is apparent that those skilled in the art can make various modifications and variations to the embodiments without departing from the scope of the disclosed embodiments. The disclosed embodiments are intended to cover the modifications and variations provided that they fall in the scope of protection defined by the following claims or their equivalents.

What is claimed is:

1. A method for bidirectional authentication, comprising:
generating, by a first network device, an inspection parameter according to a public key of a second network device and a private key of the first network device;
generating, by the second network device, an inspection parameter according to the public key of the first network device and a private key of the second network device, wherein the public key and the private key of the first network device are obtained according to an identifier of the first network device, and the public key and the private key of the second network device are obtained according to an identifier of the second network device;
authenticating, by the first network device, the second network device according to the inspection parameter generated by the first network device and the inspection parameter generated by the second network device; and
authenticating, by the second network device, the first network device according to the inspection parameter generated by the second network device and the inspection parameter generated by the first network device.

2. The method of claim 1, wherein the method further comprises:
sending, by the first network device, an authentication request to the second network device;
wherein the process of generating inspection parameter comprises:
generating, by the second network device, a first inspection parameter according to the public key of the first network device and the private key of the second network device;
generating, by the first network device, a second inspection parameter according to the public key of the second network device and the private key of the first network device, and authenticating the second network device according to the first inspection parameter and the second inspection parameter;
generating, by the first network device, a third inspection parameter according to the public key of the second network device and the private key of the first network device, and returning the third inspection parameter to the second network device; and
generating, by the second network device, a fourth inspection parameter according to the public key of the first network device and the private key of the second network device, and authenticating the first network device according to the third inspection parameter and the fourth inspection parameter; and
wherein the process of authenticating comprises:
returning, by the second network device, an authentication response inclusive of the first inspection parameter to the first network device;
authenticating, by the first network device, the second network device according to the first inspection parameter and the second inspection parameter; and
authenticating, by the second network device, the first network device according to the third inspection parameter and the fourth inspection parameter.

3. The method of claim 1, wherein the process of obtaining the public key and the private key of the first network device according to the identifier of the first network device comprises:
performing Hash function operation for the identifier of the first network device to generate a first Hash operation value, the first Hash operation value is the public key of the first network device; and
multiplying the first Hash operation value and a first private key from a network key distributor to obtain the private key of the first network device; and
wherein the process of obtaining the public key and the private key of the second network device according to an identifier of the second network device comprises:
performing Hash function operation for the identifier of the second network device to generate a second Hash operation value which is the public key of the second network device; and
multiplying the second Hash operation value and a second private key from a network key distributor to obtain the private key of the second network device.

4. The method of claim 2, wherein the process of sending the authentication request to the second network device comprises:
sending the identifier of the first network device and a first request datum obtained according to a generator of a cyclic additive group, by the first network device, as the authentication request to the second network device.

5. The method of claim 1, further comprising:
mapping, by the first network device, the public key and the private key of the first network device to elements in a cyclic multiplicative group through bilinear pairing to generate a first mapping value; and generating a first security session key according to the first mapping value and a group key;
mapping, by the second network device, the public key and the private key of the second network device to elements in a cyclic multiplicative group through bilinear pairing to generate a second mapping value; and generating a second security session key according to the second mapping value and a group key.

6. A network system, comprising:
a first network device, configured to: generate an inspection parameter according to a public key of a second network device and a private key of the first network device, receive a inspection parameter from the second network device, and perform authentication with the second network device according to the generated inspection parameter and the received inspection parameter; and
a second network device, configured to: generate an inspection parameter according to a public key of the first network device and a private key of the second network device, receive the inspection parameter from the first network device, and perform authentication with the first network device according to the generated inspection parameter and the received inspection parameter.

7. The network system of claim 6, further comprising a network key distributor, configured to generate a system parameter and a group key, and generate a private key of the first network device and a private key of the second network device respectively according to an identifier of the first network device and an identifier of the second network device;
wherein the first network device is configured: to generate a public key of the network device according to the identifier of the first network device, generate a second inspection parameter according to the public key of the second network device and the private key of the first network device, authenticate the second network device according to the first inspection parameter and the second inspection parameter, generate a third inspection parameter according to the public key of the second network device and the private key of the first network device, and return the third inspection parameter to the second network device; and
wherein the second network device is configured to: generate a public key of the second network device according to an identifier of the second network device, generate a first inspection parameter according to the public key of the first network device and the private key of the second network device, return an authentication response inclusive of the first inspection parameter to the first network device, generate a fourth inspection parameter according to the public key of the first network device and the private key of the second network device, and authenticate the first network device according to the third inspection parameter and the fourth inspection parameter.

8. A network device, comprising:
a public key and private key generating module, configured to generate a public key and a private key of the network device according to an identifier of the network device; and
an authenticating module, configured to: generate an inspection parameter according to the public key of a peer network device and the private key of the network device, receive the inspection parameter from the peer network device, and perform authentication with the peer network device according to the generated inspection parameter and the received inspection parameter.

9. The network device of claim 8, wherein the network device authenticating module comprises:
an authentication request sending unit, configured to send an authentication request to the peer network device; and
a first authenticating unit, configured to: generate a second inspection parameter according to the public key of the peer network device and the private key of the network device, authenticate the peer network device according to the first inspection parameter sent by the peer network device and the second inspection parameter, generate a third inspection parameter according to the public key of the peer network device and the private key of the network device, and return the third inspection parameter to the peer network device.

10. The network device of claim 8, wherein the public key and private key generating module comprises:
a network identifier obtaining unit, configured to obtain an identifier of the network device identifier; and
a Hash operation unit, configured to perform Hash function operation for the identifier of the network device, and generate at least one Hash operation value which is the public key of the network device.

11. The network device of claim 9, further comprising:
a first security session key generating module, configured to map the public key of the peer network device and the private key of the network device to the elements in the cyclic multiplicative group through bilinear pairing, and generate a first mapping value, and generate a first security session key according to the first mapping value and the group key.

12. The network device of claim 8, wherein the network device authenticating module comprises:
an authentication response sending unit, configured to generate a first inspection parameter according to the public key of the peer network device and the private key of the network device, and return an authentication response inclusive of the first inspection parameter to the peer network device; and
a second authenticating unit, configured to generate a fourth inspection parameter according to the public key of the peer network device and the private key of the network device, and authenticate the peer network device according to the third inspection parameter sent by the peer network device and the fourth inspection parameter.

13. The network device of claim 12, wherein the public key and private key generating module comprising:
a network identifier obtaining unit, configured to obtain a network device identifier; and
a Hash operation unit, configured to perform Hash function operation for an identifier of the network device, and generate a Hash operation value which is the public key of the network device.

14. The network device of claim 12, further comprising a second security session key generating module, configured to map the public key of the peer network device and the private key of the network device to the elements in the cyclic multiplicative group through bilinear pairing, and generate a second mapping value, and generate a second security session key according to the second mapping value and the group key.
